(19) United States
(12) Patent Application Publication
(10) Pub. No.: US 2013/0073122 A1
(43) Pub. Date: Mar. 21, 2013

(54) DRIVING ASSIST SYSTEM, IN-VEHICLE APPARATUS, SERVER, AND DRIVING ASSIST METHOD

(71) Applicant: Kazumichi Hoshiya, Kariya-city (JP)

(72) Inventor: Kazumichi Hoshiya, Kariya-city (JP)

(73) Assignee: DENSO CORPORATION, Kariya-city (JP)

(21) Appl. No.: 13/613,431

(22) Filed: Sep. 13, 2012

(30) Foreign Application Priority Data
Sep. 20, 2011 (JP) 2011-204546

(51) Int. Cl. G06F 7/00

(52) U.S. Cl. 701/2

(57) ABSTRACT

A driving assist system is disclosed. In the system, an in-vehicle apparatus measures a degree of inappropriate driving done by a driver of a own vehicle. When the degree of inappropriate driving reaches a predetermined level, the in-vehicle apparatus measures takes measures against the inappropriate driving and sends inappropriate driving information to a server. Based on the inappropriate driving information from multiple vehicles, the server identifies a risk area where the degree of inappropriate driving is prone to reach the predetermined level. The server sends a level decrease command to the multiple vehicles to request that the predetermine level be decreased in the risk area.

### CROSS REFERENCE TO RELATED APPLICATION

The present application is based on and claims priority to Japanese Patent Application No. 2011-204546 filed on Sep. 20, 2011, disclosure of which is incorporated herein by reference.

### TECHNICAL FIELD

The present disclosure relates to a driving assist system, an in-vehicle apparatus, a server, and a driving assist method for giving a warning or the like when detecting inappropriate driving such as drowsy driving, inattentive driving and the like.

### BACKGROUND

There is a driving assist apparatus which detects driver's drowsy driving or inattentive driving and gives a warning or the like. As one kind of this driving assist apparatus, a warning apparatus described in JP-2008-206688A1 corresponding to US 2008/0204256A1 gives a preliminary warning by speech, and if a driver's response is absent within a predetermined period, gives a normal warning (e.g., full scale warning) on assumption that the driver feels drowsy. This warning apparatus can prevent too much warning.

Meanwhile, when a driver gets involved in a heavy traffic jam on the way back from excursion such as sea bathing or the like, or when the driver travels on a lightly-trafficked straight road at midnight, the driver may feel drowsy while driving. Additionally, when the driver travels in an area famous for beautiful colored leaves, or when the driver travels around an advertising display on a road side, the driver may be inattentive while driving.

As can be seen from the above, the chance of drowsy driving or inattentive driving increases depending on vehicle traveling area, weather, season, time of day or the like. In these situations, it may be preferable to give a warning to the driving early than in a normal situation.

However, in the warning apparatus of JP-2008-206688A1 corresponding to US 2008/0204526A1, the predetermined period in the drowsiness detection is set constant regardless of the traveling area etc. Thus, it is difficult to give a warning about the drowsy driving in the timing appropriate to the driving area etc.

### SUMMARY

The present disclosure is made in view of the foregoing. It is an object of the present disclosure to provide a vehicle assist system, an in-vehicle apparatus, a server, and a driving assist method that can more reliably minimize inappropriate driving such as drowsy driving, inattentive driving or like.

According to a first example of the present disclosure, a driving assist system including multiple in-vehicle apparatuses and a server is provided. The multiple in-vehicle apparatuses are mounted to multiple vehicles. The serve is communicable with the multiple in-vehicle apparatuses. Each one of the multiple in-vehicle apparatuses, which is mounted to a corresponding one of the multiple vehicles referred to as an own vehicle, includes an in-vehicle-side communication device, a measuring device, a coping device, a travel place locating device, and an in-vehicle-side transmitting device. The in-vehicle-side communication device communicates with the server. The measuring device measures a degree of inappropriate driving done by a driver of the own vehicle. The coping device takes measures against the inappropriate driving when the degree of inappropriate driving reaches a predetermined coping level. The travel place locating device locates a travel place of the own vehicle. The in-vehicle-side transmitting device causes the in-vehicle side communication device to transmit inappropriate driving information, which indicates the travel place of the own vehicle located by the travel place locating device, to the server when the degree of inappropriate driving reaches the predetermined coping level. The server includes a server-side communication device, an area identifying device, and a server-side transmitting device. The server-side communication device communicates with the multiple in-vehicle apparatuses. The area identifying device identifies a risk area based on the inappropriate driving information received from the multiple in-vehicle apparatuses. The travel place or an area around the travel place in which the degree of inappropriate driving is prone to reach the predetermined coping level is identified as the risk area by the area identifying device. The server-side transmitting device causes the server-side communication device to transmit a level decrease command to the multiple vehicles. The level decrease command requests that the predetermined coping level be decreased in the risk area. In cases where (i) the coping device receives the level decrease command via the in-vehicle-side communication device and (ii) the travel place of the own vehicle is in the risk area associated with the received level decrease command, the coping device takes the measures against the inappropriate driving if the degree of inappropriate driving reaches the predetermined coping level that is decreased in accordance with the received level decrease command.

According to a second example of the present disclosure, a subject in-vehicle apparatus mounted to an own vehicle and configure to communicate with a server is provided. The subject in-vehicle apparatus includes a measurement device, a coping device, a travel place locating device, an in-vehicle-side communication device, and an in-vehicle-side transmitting device. The measurement device measures a degree of inappropriate driving done by a driver of the own vehicle. The coping device takes measures against the inappropriate driving when the degree of inappropriate driving reaches a predetermined coping level. The travel place locating device locates a travel place of the own vehicle. The in-vehicle-side communication device communicates with the server, where: the server collects inappropriate driving information, which indicates the travel place where the degree of inappropriate driving reaches the predetermined coping level, from the subject in-vehicle apparatus and other in-vehicle apparatuses; the server identifies a risk area based on the collected inappropriate driving information; the travel place or an area around the travel place in which the degree of inappropriate driving is prone to reach the predetermined coping level is identified as the risk area by the server; and the server transmits a level decrease command, which requests that the predetermined coping level be decreased in the risk area, to the subject in-vehicle apparatus and the other in-vehicle apparatuses. The in-vehicle-side transmitting device causes the in-vehicle-side communication device to transmit the inappropriate driving information, which indicates the travel place of the own vehicle located by the travel place locating device, to the server when the degree of inappropriate driving reaches the predetermined coping level. In cases where (i) the coping device receives the level decrease command via the in-vehicle-side communication device and (ii) the travel place of the own vehicle is in the risk area associated with the received level decrease command, the coping device takes the measures against the inappropriate driving if the degree of inappropriate driving reaches the predetermined coping level that is decreased in accordance with the received level decrease command.

According to a third example of the present disclosure, a server communicable with multiple in-vehicle apparatuses is provided. The server includes a server-side communication device, an area identifying device, and a server-side transmitting device. The server-side communication device communicates with the multiple in-vehicle apparatuses, which are mounted to multiple vehicles, respectively. The area identifying device identifies a risk area based on inappropriate driving information received from the multiple in-vehicle apparatuses. The inappropriate driving information received from each one of the plurality of in-vehicle apparatuses indicates a travel place of a corresponding one of the multiple vehicles when the degree of inappropriate driving reaches a predetermined coping level. The travel place or an area around the travel place in which the degree of inappropriate driving is prone to reach the predetermined coping level is identified as the risk area by the area identifying device. The server-side transmitting device causes the server-side communication device to transmit a level decrease command to the multiple vehicles, the level decrease command requesting that the predetermined coping level be decreased in the risk area.

According to a fourth example of the present disclosure, a driving assist method is provided. The driving assist method includes: measuring, with use of each of in-vehicle apparatuses, a degree of inappropriate driving done by a driver of an own vehicle, which is a vehicle equipped with the each of the in-vehicle apparatuses; taking measures, with use of each of the in-vehicle apparatuses, against the inappropriate driving when the degree of inappropriate driving reaches a predetermined coping level; transmitting inappropriate driving information from each of the in-vehicle apparatuses to a server, where the inappropriate driving information indicates a travel place of the own vehicle when the degree of inappropriate driving reaches the predetermined coping level; identifying a risk area based on the inappropriate driving information received from the in-vehicle apparatuses, where the travel place or an area around the travel place in which the degree of inappropriate driving is prone to reach the predetermined coping level is identified as the risk area by the server; and transmitting a level decrease command, which requests that the predetermined coping level be decreased in the risk area, from the server to the in-vehicle apparatuses. In cases where (i) the level decrease command is received via the in-vehicle-side communication device and (ii) the travel place of the own vehicle is in the risk area associated with the received level decrease command, the measures against the inappropriate driving are taken in the own vehicle if the degree of inappropriate driving reaches the predetermined coping level that is decreased in accordance with the received level decrease command.

According to the above vehicle assist system, the above subject in-vehicle apparatus, the server, and the driving assist method, it is possible to reliably minimize inappropriate driving such as drowsy driving, inattentive driving or like.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a block diagram illustrating a driving assist system;

FIG. 1B is a block diagram illustrating an in-vehicle assist system;

FIG. 2A is a block diagram illustrating a driver monitor;

FIG. 2B is a block diagram illustrating a server;

FIG. 3 is a diagram illustrating a warning level map;

FIG. 4 is a flowchart illustrating a driver monitor process;

FIG. 5 is a flowchart illustrating a warning level setting process; and

FIG. 6 is a flowchart illustrating a warning level information receipt process.

### DETAILED DESCRIPTION

An embodiment will be described with reference to the drawings. It should be noted that the below-described embodiment does not limit embodiments of the present disclose. Embodiments of the present disclosure can have various forms within sprit and scope of the present disclosure.

### (Configuration)

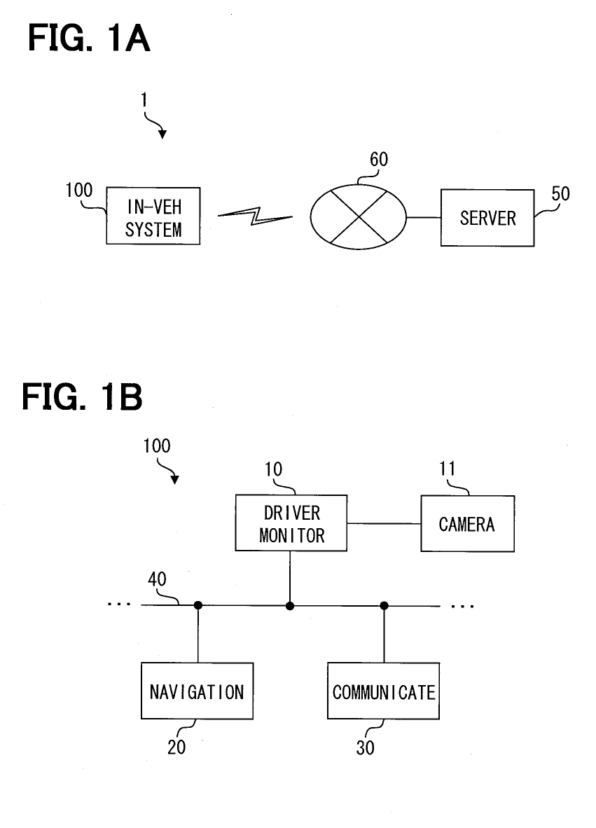

As shown in FIG. 1A, a driving assist system 1 of one embodiment includes multiple in-vehicle systems and a server 50. The multiple in-vehicle systems 100 are mounted to multiple vehicles. The server 50 is communicable with each in-vehicle system 100 over Internet 60. The in-vehicle system 100 detects the drowsy driving (feels drowsy while driving) and the inattentive driving (looking aside while driving), and gives a warning or the like. A warning level, which is used in determining whether the warning or the like should be given, is set by the server 50 and notified to the in-vehicle system 100.

As shown in FIG. 1B, the in-vehicle system 100 includes a driver monitor 10, a navigation apparatus 20, and a communication device 30, which are connected with each other via an in-vehicle LAN such as CAN or the like. The driver monitor 10 photographs a face of the driver with a camera 11 to detect the drowsy driving or the like. The navigation apparatus 20 performs route guidance or the like with use of map data. The communication device 30 includes an antenna (not shown) or the like, and communicates with the server 50 by accessing Internet 60 with use of a wireless communication network.

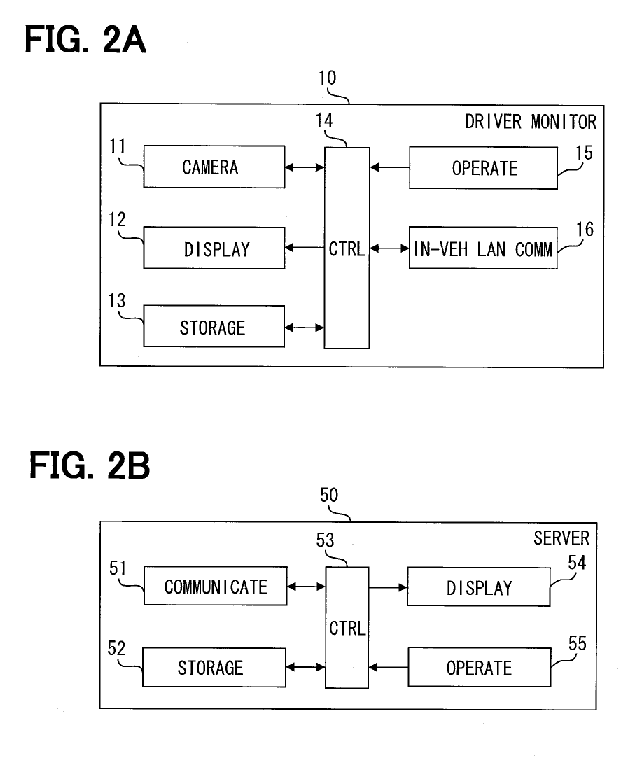

As shown in FIG. 2A, the driver monitor 10 includes the camera 11, which illuminates the face of the driver seated on a driver seat and photographs the face of the driver. Additionally, the driver monitor 10 includes a display 12, a storage 13, a controller 14, an operation device 15, and an in-vehicle LAN communication device 16. The display 12 includes a LCD or the like and displays a variety of information. The storage 13 includes a non-volatile memory or the like, which may be a flash memory or the like. The controller 14 includes a microcomputer with a CPU, a ROM, a RAM, an I/O and a bus line connecting the foregoing components. The controller 14 operates in accordance with a program or the like stored in the ROM, and has a time function and a calendar function. The operation device 15 includes a button or the like to receive various operations. The in-vehicle LAN communication device 16 performs communications with another apparatus via the in-vehicle LAN 40.

As shown in FIG. 2B, the server 50 includes a communication device 51 and a storage 52. The communication device 51 can be used to access Internet 60. The storage 52 includes a device that can retain the stored information without storage-retain operation. For example, the storage 52 includes HDD or the like. The server 50 further includes a controller 53, a display 54, and an operation device 55. The controller 53 includes a microcomputer with a CPU, a ROM, a RAM, an I/O and a bus line connecting the foregoing components. The controller 53 operates in accordance with a program loaded to the RAM. The display 54 may include a liquid crystal display (LCD) or the like, and displays a variety of information. The operation device 55 may include a keyboard, a mouse or the like to receive various user operations.

### (Operation)

(1) Outline

An outline of operation of the driving assist system 1 will be described.

The in-vehicle system 100 measures a degree of inappropriate driving (e.g., drowsy driving, inattentive driving) done by the driver. The degree of inappropriate driving is also referred to as an inappropriate driving level. When the inappropriate driving level, which may be an inappropriate driving level of the drowsy driving or an inappropriate driving level of the inattentive driving, reaches the warning level, the in-vehicle system 100 gives a warning.

The in-vehicle system 100 identifies (i) a road section where one inappropriate driving level reaches the warning level and (ii) a travel condition (e.g., vehicle traveling direction in the road section, season) at the traveling in the road section. The in-vehicle system 100 transmits inappropriate information to the server 50. The inappropriate information indicates a corresponding inappropriate driving type, identification information (ID) uniquely assigned to the road section, and the travel condition.

The road section may be, for example, a link of road registered in the map data of the navigation apparatus 20. Alternatively, the road section may be a segmentalized part of a link of road registered in the map data of the navigation apparatus 20. The server 50 collects the inappropriate driving information from the multiple in-vehicle systems 100, and classifies the inappropriate driving information according to road section. Additionally, for each travel condition, the server 50 counts the number of times the inappropriate driving level reaches a warning level in each road section, based on the classified inappropriate driving information. The number of times the inappropriate driving level reaches the warning level is also referred to as the number of warning. Based on the counted numbers of warning, the server 50 sets the warning levels for the respective road sections under each travel condition.

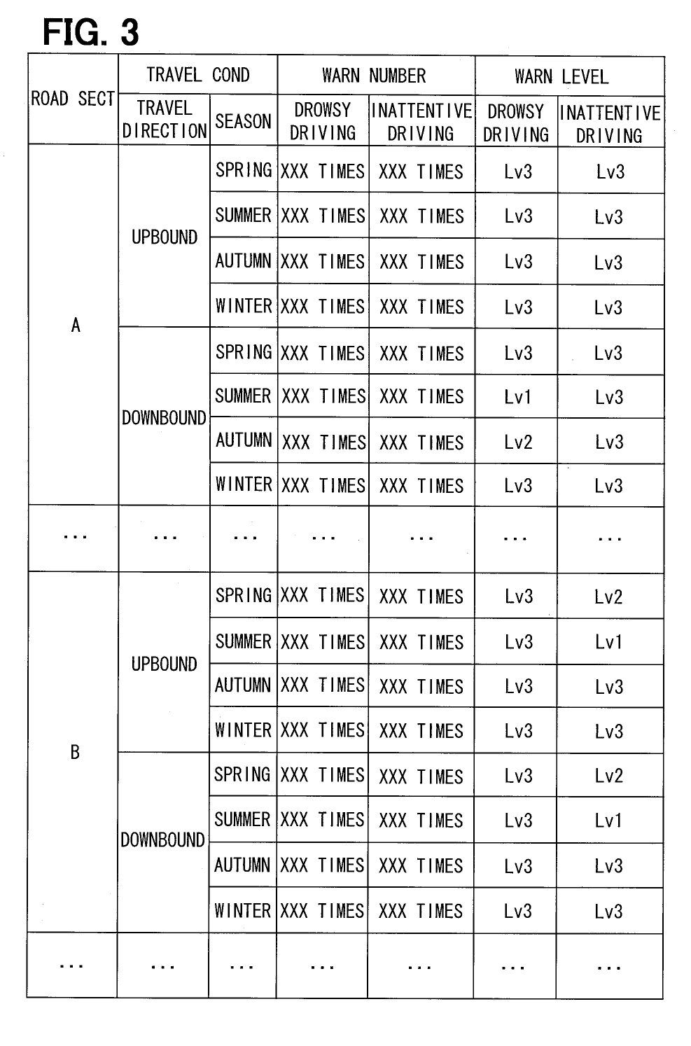

FIG. 3 is a diagram illustrating a warning level map, which describes the number of warning counted for each road section on a travel-condition-by-travel-condition basis and which describes the warning level under each travel condition. The warning level is set based on the number of warning.

In the warning level map of FIG. 3, there are an item “road section”, an item “travel condition”, an item “the number of warning” and an item “warning level”. The item “road section” is for describing the identification information corresponding to the road section. The item “travel condition is for describing the travel condition. The item “the number of warning” is for describing the number of warning about the drowsy driving and that about the inattentive driving. The item “warning level” is for describing the warning levels of the drowsy driving and the inattentive driving.

In “travel condition”, there are an item “traveling direction” for describing the traveling direction of the own vehicle in the corresponding to road section and an item “season” for describing the season in which the own vehicle travels the corresponding road section.

In “the number of warning”, there are an item “drowsy driving” for describing the number of warning about the drowsy driving in the corresponding road section and the corresponding travel condition, and an item “inattentive driving” for describing the number of warning about the inattentive driving in the corresponding road section and the corresponding travel condition. In “warning level”, there are an item “drowsy driving” for describing the warning level of the drowsy driving in the corresponding road section and the corresponding travel condition, and an item “inattentive driving” for describing the warning level of the inattentive driving in the corresponding road section and the corresponding travel condition.

The server 50 creates the warning level map based on the collected inappropriate driving information and stores the warning level map in the storage 52.

The traveling direction is set to one of “up-bound” and “down-bound”, which are directions with a reference point and are opposite to each other. The season is set to one of “spring”, “summer”, “autumn”, and “winter”. The warning level is set between “Lv1 to Lv3”, so that as the warning level is lower, the warning is given at a lower inappropriate driving level and the warning about inappropriate driving is frequently given.

For each road section and each travel condition, an initial value of the warning level is Lv3, and the warning level is decreased as the number of warning increases. Specifically, for each inappropriate driving, a threshold of the number of warning for decreasing the warning level may be set. For example, when the number of warning about the drowsy driving reaches 1000, the warning level of the drowsy driving is set to Lv2. When the number of warning about the drowsy driving reaches 3000, the warning level of the drowsy driving is set to Lv1.

When the warning level corresponding to (i) a certain inappropriate driving and (ii) a specific travel condition in a specific road section is updated to a certain level, the warning levels corresponding to (i) the same kind of inappropriate driving and (ii) the specific travel condition in road sections adjacent to the specific road section may be also set to the certain level.

When the warning level corresponding to (i) a certain type of inappropriate driving and (ii) a specific travel condition in a specific road section is updated to a certain level, a road section that the vehicle travels just before traveling the specific road section may be identified based on the traveling direction indicated by the travel condition. Thereafter, the warning level corresponding to (i) the same type of inappropriate driving and (ii) the specific condition in the identified road section may be set to the certain level.

After updating the warning level, the server 50 transmits the warning level information to each in-vehicle system 100. The warning level information indicates a type of inappropriate driving corresponding to the updated warning level, the identification information of the road section, the travel condition, and the updated warning level.

In the in-vehicle system 100, the communication device 30 receives the warning level information from the server 50 and provides the received warning level information to the driver monitor 10. Upon receipt of the warning level information, the driver monitor 10 stores the received warning level information in the storage 13. Thereafter, when the vehicle travels the road section corresponding to the warning level information under the travel condition indicated by the warning level information, the driver monitor 10 uses the warning level indicated by the warning level information to give a warning about the drowsy driving or the inattentive driving. It should be noted that when there are multiple warning levels for the same road section, the same driving condition and the same type of inappropriate driving, the warning level indicated by the latest warning level information may be used to give a warning.

(2) Measurement of Inappropriate Driving Level

The measurement of inappropriate driving level will be described. Based on the image of the driver's face photographed with the camera 11, the driver monitor 10 measures drowsiness level of the driver and uses this drowsiness level as the inappropriate driving level. In the above, the drowsiness level is measured as a value from 0 to 5 in unit of minimum increment of 0.1. The level 0 refers to the driver in a wakeful state. The level 5 refers to the driver in a completely sleeping state.

For example, the driver monitor 10 measures a distance from a left corner of a mouth to a right corner of the mouth, a distance from an eyebrow center to a center point between an inner corner of an eye and an outer corner of the eye, a frontward/backward inclination a head, or the like. These measurement results are compared with those at a time of the wakeful state.

For example, when the warning level is Lv3, the threshold of the drowsiness level is set to 2.6. When the warning level is Lv2, the threshold of the drowsiness level is set to 2.5. When the warning level is Lv1, the threshold of the drowsiness level is set to 2.4. If the drowsiness level exceeds the threshold the predetermined number of times within a predetermined time period, the warning is given.

The measurement of the inappropriate driving level of the drowsy driving is not limited to the above-described example. For example, a time period during which the drowsy level exceeds the threshold may be measured, and the warning may be given when the measured time period exceeds a threshold that is set according to the warning level.

Next, the measurement of the inappropriate driving level of the inattentive driving will be described. Based on the image of the driver's face photographed with the camera 11, the driver monitor 10 measures a looking-aside angle, which is a leftward/rightward angle of the driver's face with respect to the driver's face that faces in the heading direction of the vehicle. Specifically, based on the image of the face, the driver monitor 10 identifies a characteristic point on the driver's face and measures the orientation of the face. Based on the characteristic point and the orientation of the face, the driver monitor 10 measures the looking-aside angle.

When the looking-aside angle becomes equal to or greater than 30 degrees, the driving is deemed the inattentive driving. When the driving is deemed the inattentive driving and thereafter the looking-aside angle becomes equal to or less than 10 degrees, the inattentive driving is deemed remedy. In this case, a duration time of the inattentive driving is measured as the inappropriate driving level.

For example, when the warning level is Lv3, a determination time is set to 2.5 seconds. When the warning level is Lv2, the determination time is set to 2.0 seconds. When the warning level is Lv1, the determination time is set to 1.5 seconds. If the inattentive driving continues for the determination time, the warning is given.

The measurement of the inappropriate driving level of the inattentive driving is not limited to the above-described example. For example, the number of times the inattentive driving is done within a certain time period is measured as the inappropriate driving level. When this number of times exceeds a threshold that is set according to the warning level, the warning is given.

(3) Driver Monitor Process

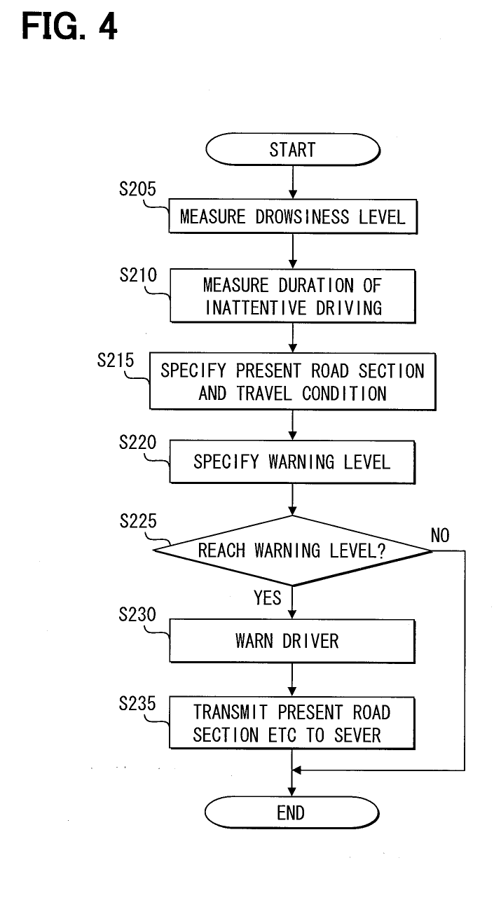

A driver monitor process, which measures the drowsiness level of the driver or the duration time of the inattentive driving and gives a warning to the driver in accordance with a measurement result, will be described with reference to a flowchart of FIG. 4. The driver monitoring process is periodically performed by the driver monitor 10.

At S205, in the above-described way, the controller 14 of the driver monitor 10 measures the drowsiness level (inappropriate driving level) of the driver based on the image of the face photographed with the camera 11. After S205, the process proceeds to S210.

At S210, in the above-described way, the controller 14 determines whether or not the inattentive driving is done, based on the image of the face photographed with the camera 11. When the inattentive driving is done, the duration time (inappropriate driving level) of the inattentive driving is measured. After S210, the process proceeds to S215.

At S215, from the navigation apparatus 20 via the in-vehicle LAN 40, the controller 14 receives (i) the identification information corresponding to the road section in which the own vehicle is traveling and (ii) the traveling direction of the own vehicle in the road section. Additionally, the controller 14 determines the present year-month-day-time by using the time function and the calendar function, and identifies the present season as one of spring, summer, autumn and winter based on the present year-month-day-time. After S215, the process proceeds to S220.

At S220, the controller 14 scans the warning level information stored in the storage 13 and searches for the latest warning level information that corresponds to (i) the road section indicated by the received identification information and (ii) the travel condition (e.g., the traveling direction, the season). When the controller 14 successfully retrieves the corresponding warning level information, the controller 14 sets the warning level of the corresponding inappropriate driving based on the retrieved warning level information. When the retrieval of the corresponding warning level information ends unsuccessful, the warning level is set to Lv3. After S220, the process proceeds to S225.

At S225, the controller 14 determines whether or not the inappropriate driving level of at least one of the drowsy driving and the inattentive driving reaches the warning level. When a determination result at S225 is affirmative (YES at S225), the process proceeds to S230. When the determination result at S225 is negative (NO at S225), this driver monitor process is ended.

At S230, via the display of the navigation apparatus 20 or the speaker (not shown), the controller 14 gives a warning about the inappropriate driving whose inappropriate driving level has reached the warning level. At S230, in addition to or in place of giving the warning, the controller 14 may reduce speed of the own vehicle or may stop the own vehicle. After S230, the process proceeds to S235.

At S235, the controller 14 transmits the inappropriate driving information, which includes (i) the identification information of the present road section acquired at S215, (ii) the travel condition and (iii) an inappropriate driving type associated with the warning, to the communication device 30 via the in-vehicle LAN 40. Additionally, the controller 14 causes the communication device 30 to transmit the inappropriate driving information to the server 50. After S235, the driver monitor process is ended.

(4) Warning Level Setting Process

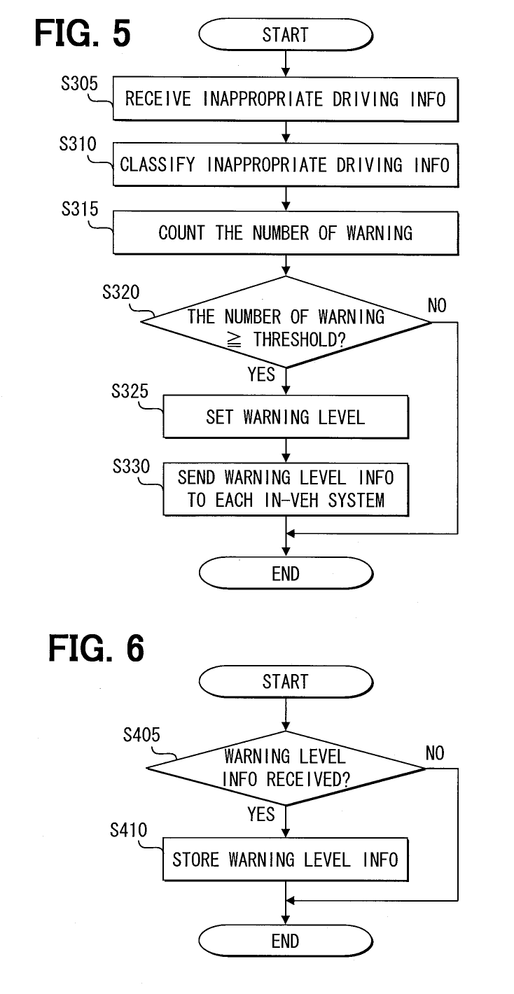

In a warning level setting process, the server 50 collects the inappropriate driving information from the in-vehicle systems 100, and sets the warning levels corresponding to the respective travel conditions in each road section based on the inappropriate driving information. The warning level setting process will be more specifically described with reference to a flowchart of FIG. 5. The warning level setting process is periodically performed by the server 50.

At S305, the controller 53 of the server 50 receives the inappropriate driving information from one or more in-vehicle systems 100 via the communication device 51. After S305, the process proceeds to S310. At S310, the controller 53 classifies the received inappropriate driving information according to the road section indicated by this inappropriate driving information. After S310, the process proceeds to S315.

At S315, based on the inappropriate driving information grouped according to road section, the controller 53 counts the number of warning about the drowsy driving and that about the inattentive driving under each driving condition on a road-section-by-road-section basis. Additionally, the controller 53 accesses the warning level map and updates the number of warning about the drowsy driving and that about the inattentive driving. In the above, the number of warning corresponding to each road section and each travel condition may be updated. After S315, the process proceeds to S320.

At S320, the controller 53 determines whether or not the road section and the travel condition in which the number of warning about the drowsy driving reaches the threshold. When a determination result at S320 is affirmative (YES at S320), the process proceeds to S325. When the determination result at S320 is negative (NO at S320), this process is ended.

At S325, the controller 53 accesses the warning level map and updates the warning level corresponding to (i) the road section, (ii) the travel condition and (iii) the inappropriate driving type that are associated with the number of warning having reached the threshold.

At S330, the controller 53 generates the warning level information, which indicates the updated warning level and further indicates the road section, the travel condition and the inappropriate driving type that correspond to the updated warning level. Additionally, at S330, the controller 53 transmits the warning level information to each in-vehicle system via the communication device 51. After S330, the warning level setting process is ended.

(5) Warning Level Information Receipt Process

A warning level information receipt process for the driver monitor 10 of the in-vehicle system 100 to receive the warning level information from the server 50 will be described with reference to a flowchart of FIG. 6. The warning level information receipt process is periodically performed by the driver monitor 10.

At S405, the controller 14 of the driver monitor 10 communicates with the communication device 30 via the in-vehicle LAN 40 and determines whether or not the warning level information is received. When a determination result at S405 is affirmative (YES at 405), the process proceeds to S410. When the determination result at S405 is negative, the warning level information receipt process is ended.

At S410, the controller 14 receives the warning level information from the communication device 30 and stores the received warning level information in the storage 13. After S410, the warning level information receipt process is ended.

### (Advantage)

The in-vehicle system of the driving assist system 1 of the present embodiment measures a degree of inappropriate driving such as drowsy driving and inattentive driving. The degree of inappropriate driving is also referred to herein as the inappropriate driving level. When the inappropriate driving level reaches the warning level, the warning is given to the driver. Additionally, the inappropriate driving information indicative of the corresponding inappropriate driving type (e.g., drowsy driving and inattentive driving), the traveling road section and the travel condition is generated and transmitted to the server 50.

The server 50 collects the inappropriate driving information from respective in-vehicle systems 100, counts (i) the number of warning about the drowsy driving for each road section on a travel condition-by-travel-condition basis and (ii) the number of warning about the inattentive driving for each road section on a travel-condition-by-travel-condition basis. When the number of warning about a certain inappropriate driving type in a certain road section and a certain travel condition reaches a prescribed value, the server 50 lowers the warning level of the certain inappropriate driving type in the certain road section and the certain travel condition. The server 50 generates the warning level information which indicates the lowered warning level, the certain inappropriate driving type, the certain road section and the certain travel condition, and transmits the generated warning level information to the server 50.

The in-vehicle system 100 receives the warning level information from the server 50 and accumulates the warning level information. As for the travel place and the travel condition indicated by the warning level information, the warning is given at a stage where the corresponding inappropriate driving level reaches the waning level indicated by the warning level information. Therefore, in the travel place and the travel condition (specifically, the travel place and the travel condition where the drowsy driving or the like is prone to occur), it is possible to early give the warning about the drowsy driving or the like, and accordingly, it is possible to reliably prevent the drowsy driving or the like.

### Other Embodiments

(1) In the above embodiment, the warning level information is provided from the server 50 to the in-vehicle system 100 via Internet 60 or the like. However, this example does not limit the way of providing the warning level information. For example, the warning level information may be provided via, for example, a beacon on a road side. Additionally, when the warning level information is provided via the beacon in a certain road section, the warning level information of the certain road section and road sections around the certain road section may be provided. In this configuration, the same advantage can be obtained.

(2) In the above embodiment, the drowsy driving and the inattentive driving are described as the inappropriate driving. However, this does not limit the inappropriate driving. For example, the inappropriate driving may include highly-fuel-consuming driving, accident-inducible driving. In the above, the accident-inducible driving may refer to driving with a high frequency of excessive speed or sudden acceleration.

In the above embodiment, (i) the traveling direction in the road section and (ii) the season in which the vehicle travels the road section are used as the travel condition. However, this does not limit the travel condition. For example, the travel condition may include a time of day (early morning, nighttime, midnight etc.), weather or the like when the vehicle travels the road section.

Additionally, the in-vehicle system 100 may not detect the travel condition and may generate the inappropriate driving information that indicates only the identification information of the road section in which the inappropriate driving level about the drowsy driving, the inattentive driving or the like reaches the warning level. The in-vehicle system 100 may transmit this inappropriate driving information to the server 50.

Thereafter, based on the inappropriate driving information, the server 50 may count the number of warning about each inappropriate driving, and may set the warning level of each inappropriate driving on a road-section-by-road section basis without taking into account the travel condition. Additionally, when updating the warning level, the server 50 may generate the warning level information that indicates (i) the updated warning level and (ii) the road section and the inappropriate driving type corresponding to the updated warning level. Then the server 50 may transmit the generated warning level information to the in-vehicle systems 100. Based on the received warning level information, the in-vehicle system 100 may set the warning level of each road section without taking into account the travel condition.

In the above case, substantially the same advantages can be obtained.

(3) When lowering a warning level, the server 50 may communicate with an electronic indicator disposed in a road section corresponding to the warning level, so that the warning about the corresponding inappropriate driving is given to the vehicle that is under the corresponding travel condition. In this way, it is possible to efficiently prevent the drowsy driving or the inattentive driving.

### (Aspects)

In the above embodiments, the in-vehicle system 100 may correspond to an example of in-vehicle apparatus. The communication device 30 may correspond to an example of in-vehicle-side communication device and means. The navigation apparatus 20 may correspond to an example of travel place locating device or means. The communication device 51 of the server 50 may correspond to an example of server-side communication device or means.

S205 and S210 in the driver monitor process, which may be performed by the controller 14 of the driver monitor 10, may correspond to an example of measuring device or means, and an example of measuring step. S220 to S230, which may be performed by the controller 14 of the driver monitor 10, may correspond to an example of coping device or means, and an example of coping step. S235, which may be performed by the controller 14 of the driver monitor 10, may correspond to an example of in-vehicle-side transmission device or means, and an example of in-vehicle-side transmission step.

S310 to S325 in the warning level setting process, which may be performed by the controller 53 of the server 50, may correspond to an example of area identifying device or means, and an example of area identifying step. S330, which may be performed by the controller 53 of the server 50, may correspond to an example of server-side transmission device or means, and an example of server-side transmission step. The warning or the like about inappropriate driving may correspond to an example of measures against inappropriate driving. The road section may correspond to an example of travel place. The warning level may correspond to an example of coping level. The warning level information may correspond to an example of level decrease command.

The road section and the travel condition indicated by the warning level information may correspond to an example of risk area and an example of risk travel situation, respectively.

According to the present disclosure, a vehicle assist system, an in-vehicle apparatus, a server, and a driving assist method can provided in various forms. For example, in a first example, a vehicle assist system may include multiple in-vehicle apparatuses mounted to multiple different vehicles and a server communicable with the respective in-vehicle apparatuses.

Each one of the multiple in-vehicle apparatuses, which is mounted to a corresponding one of the multiple vehicles referred to as an own vehicle, may include an in-vehicle-side communication device, a measuring device, a coping device, a travel place locating device, and an in-vehicle-side transmitting device. The in-vehicle-side communication device may communicate with the server. The measuring device may measure a degree of inappropriate driving done by a driver of the own vehicle. The coping device may take measures against the inappropriate driving when the degree of inappropriate driving reaches a predetermined coping level. The travel place locating device may locate a travel place of the own vehicle. The in-vehicle-side transmitting device may cause the in-vehicle side communication device to transmit inappropriate driving information, which indicates the travel place of the own vehicle located by the travel place locating device, to the server when the degree of inappropriate driving reaches the predetermined coping level.

The server may include a server-side communication device, an area identifying device, and a server-side transmitting device. The server-side communication device may communicate with the multiple in-vehicle apparatuses. The area identifying device may identify a risk area based on the inappropriate driving information received from the multiple in-vehicle apparatuses, such that the travel place or an area around the travel place in which the degree of inappropriate driving is prone to reach the predetermined coping level is identified as the risk area by the area identifying device. The server-side transmitting device may cause the server-side communication device to transmit a level decrease command to the multiple vehicles, where the level decrease command requests that the predetermined coping level be decreased in the risk area.

In cases where (i) the coping device receives the level decrease command via the in-vehicle-side communication device and (ii) the travel place of the own vehicle is in the risk area associated with the received level decrease command, the coping device may take the measures against the inappropriate driving if the degree of inappropriate driving reaches the predetermined coping level that is decreased in accordance with the received level decrease command.

The measures against the inappropriate driving may include, for example, giving a warning to the driver through speech or image. In addition to or in place of the example, the measures against the inappropriate driving may include, decreasing the speed of the own vehicle, stopping the own vehicle, or the like.

The inappropriate driving may include at least one of drowsy driving and inattentive driving.

According to the above configuration, the travel place (or the area around the travel place) where the inappropriate driving is prone to be done can be identified as the risk area by the server, and additionally, the server can transmit the level decrease command to the in-vehicle apparatuses to lower the coping level, which is used in making a determination as to whether the measure against the inappropriate driving should be taken when the vehicle travels the risk area.

When the in-vehicle apparatus receives the level decrease command, the in-vehicle apparatus in the risk area associated with the received level decrease command can take the measures against the inappropriate driving at a stage where the degree of the inappropriate driving reaches the coping level that is lower than in other places. Therefore, it is possible to prompt the driver to recover from the inappropriate driving early, and accordingly, it is possible to reliably prevent the inappropriate driving such as drowsy driving, inattentive driving or the like.

It is conceivable that the even when the vehicle travels the same travel place, the frequency of inappropriate driving may vary depending on a travel condition such as a driving time, a vehicle heading direction and the like. In view of this, the in-vehicle apparatus of the driving assist system may further include a determination device that determines a travel condition of the own vehicle when the own vehicle travels the travel place located by the travel place locating device.

Furthermore, when the degree of inappropriate driving reaches the predetermined coping level, the in-vehicle-side transmitting device may transmit the inappropriate driving information which indicates, in addition to the travel place, the travel condition in the travel place determined by the determination device. Based on the inappropriate driving information received from the multiple in-vehicle apparatuses, the area identifying device may identify, in addition to the risk area, a risk travel situation in the risk area, such that the travel condition that occurs with predetermined high frequency or more in the risk area when the degree of the inappropriate driving reaches the predetermined coping level is identified as the risk travel situation;

Additionally, the level decrease command transmitted from the server-side transmitting device to the multiple in-vehicle apparatuses may request that when the travel condition of the own vehicle corresponds to the risk travel situation in the risk area, the predetermined coping level be decreased. When receiving the level decrease command, the coping device may take the measures provided that (i) the travel place of the own vehicle is in the risk area associated with the received level decrease command and (ii) the travel condition determined by the determination device corresponds to the risk travel situation associated with the received level decrease command.

The travel condition includes at least one of a time when the own vehicle travels the travel place and a traveling direction of the own vehicle in the travel place. According to the above configuration, the server can determine under which travel condition the inappropriate driving is prone to be done in the risk area. Additionally, to the in-vehicle apparatuses, the server can transmit the level decrease command to decrease the coping level, which can used in determining whether the measures against the inappropriate driving should be taken in the vehicle which travels the risk area under the travel condition (risk travel condition) that is prone to cause the inappropriate driving.

When the in-vehicle apparatus, which has received the level decrease command, travels the risk area under the risk travel condition associated with the level decrease command, the in-vehicle apparatus can take the measures against the inappropriate driving at a stage where the degree of inappropriate driving reaches a lower coping level than in another place or another travel condition. Therefore, it is possible to encourage the driver to recover from the inappropriate driving early, and accordingly, it is possible to reliably prevent the inappropriate driving such as drowsy driving, inattentive driving or the like.

The in-vehicle apparatus itself or the server itself, which are components of the driving assist system, can be distributed to market. For example, a subject in-vehicle apparatus, which is mounted to an own vehicle and configure to communicate with a server, may be configured as follows.

For example, an in-vehicle apparatus mounted to a vehicle and configured to communicate with a server located outside of the vehicle may include: a measurement device that measures a level of inappropriate driving done by a driver of the vehicle; a warning device that warns the driver against the inappropriate driving when the level of inappropriate driving reaches a threshold level; a location determining device that determines a location of the vehicle; and an in-vehicle-side communication device that communicates with the server. The threshold level depends on a location of the vehicle. The server collects inappropriate driving information from a plurality of vehicles. The inappropriate information indicates a location where the level of inappropriate driving reaches the threshold level. The server identifies a risk area based on the collected inappropriate driving information. The server transmits a level decrease command to the in-vehicle apparatus. The level decrease command requests the in-vehicle apparatus to decrease the threshold level of the risk area. The in-vehicle-side communication device transmit the inappropriate driving information to the server. In cases where the in-vehicle apparatus receives the level decrease command, said warning device warns the driver based on the level of inappropriate driving and a decreased threshold level caused by the level decrease command.

Alternatively, a subject in-vehicle apparatus may include a measurement device, a coping device, a travel place locating device and an in-vehicle-side communication device. The measurement device measures a degree of inappropriate driving done by a driver of the own vehicle. The coping device takes measures against the inappropriate driving when the degree of inappropriate driving reaches a predetermined coping level. The travel place locating device locates a travel place of the own vehicle, The in-vehicle-side communication device communicates with the server, where: the server collects inappropriate driving information, which indicates the travel place where the degree of inappropriate driving reaches the predetermined coping level, from the subject in-vehicle apparatus and other in-vehicle apparatuses; the server identifies a risk area based on the collected inappropriate driving information; the travel place or an area around the travel place in which the degree of inappropriate driving is prone to reach the predetermined coping level is identified as the risk area by the server; the server transmits a level decrease command, which requests that the predetermined coping level be decreased in the risk area, to the subject in-vehicle apparatus and the other in-vehicle apparatuses.

The subject in-vehicle apparatus may further include an in-vehicle-side transmitting device that causes the in-vehicle-side communication device to transmit the inappropriate driving information, which indicates the travel place of the own vehicle located by the travel place locating device, to the server when the degree of inappropriate driving reaches the predetermined coping level. In cases where (i) the coping device receives the level decrease command via the in-vehicle-side communication device and (ii) the travel place of the own vehicle is in the risk area associated with the received level decrease command, the coping device takes the measures against the inappropriate driving, provided that the degree of inappropriate driving reaches the predetermined coping level that is decreased in accordance with the received level decrease command.

According to another example, a server communicable with multiple in-vehicle apparatuses may be configured as follows.

The server may include a server-side communication device, an area identifying device, and a server-side transmitting device. The server-side communication device may communicate with the in-vehicle apparatuses, wherein the multiple in-vehicle apparatuses are mounted to multiple vehicles, respectively. The area identifying device may identify a risk area based on inappropriate driving information received from the multiple in-vehicle apparatuses, where: the inappropriate driving information received from each one of the multiple n-vehicle apparatuses indicates a travel place of a corresponding one of the multiple vehicles when the degree of inappropriate driving reaches a predetermined coping level; and the travel place or an area around the travel place in which the degree of inappropriate driving is prone to reach the predetermined coping level is identified as the risk area by the area identifying device. The server-side transmitting device may cause the server-side communication device to transmit a level decrease command, which requests that the predetermined coping level be decreased in the risk area, to the multiple vehicles.

Accordingly, when the above in-vehicle apparatus itself and the sever itself are distributed to market, the distributed in-vehicle apparatus or sever can prevent the inappropriate driving such as drowsy driving, inattentive driving or the like in cooperation with a corresponding server or a corresponding in-vehicle apparatus.

According to another aspect, a driving assist method is provided. The driving assist method includes: measuring, with use of each of in-vehicle apparatuses, a degree of inappropriate driving done by a driver of an own vehicle, which is a vehicle equipped with the each of the in-vehicle apparatuses; taking measures, with use of each of the in-vehicle apparatuses, against the inappropriate driving when the degree of inappropriate driving reaches a predetermined coping level; transmitting inappropriate driving information from each of the in-vehicle apparatuses to a server, where the inappropriate driving information indicates a travel place of the own vehicle when the degree of inappropriate driving reaches the predetermined coping level; identifying a risk area based on the inappropriate driving information received from the in-vehicle apparatuses, where the travel place or an area around the travel place in which the degree of inappropriate driving is prone to reach the predetermined coping level is identified as the risk area by the server; and transmitting a level decrease command, which requests that the predetermined coping level be decreased in the risk area, from the server to the in-vehicle apparatuses. In cases where (i) the level decrease command is received via the in-vehicle-side communication device and (ii) the travel place of the own vehicle is in the risk area associated with the received level decrease command, the measures against the inappropriate driving are taken in the own vehicle provided that the degree of inappropriate driving reaches the predetermined coping level that is decreased in accordance with the received level decrease command.

According to the above driving assist method, it is also possible to reliably prevent the inappropriate driving such as drowsy driving, inattentive driving or the like.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A driving assist system comprising:
a plurality of in-vehicle apparatuses that is mounted to a plurality of vehicles, respectively; and
a server that is communicable with the plurality of in-vehicle apparatuses,
wherein each of the plurality of in-vehicle apparatuses, which is mounted to a corresponding one of the plurality of vehicles referred to as an own vehicle, includes:
an in-vehicle-side communication device that communicates with the server;
a measuring device that measures a degree of inappropriate driving done by a driver of the own vehicle;
a coping device that takes measures against the inappropriate driving when the degree of inappropriate driving reaches a predetermined coping level;
a travel place locating device that locates a travel place of the own vehicle; and
an in-vehicle-side transmitting device that causes the in-vehicle side communication device to transmit inappropriate driving information, which indicates the travel place of the own vehicle located by the travel place locating device, to the server when the degree of inappropriate driving reaches the predetermined coping level,
wherein the server includes:
a server-side communication device that communicates with the plurality of in-vehicle apparatuses;
an area identifying device that identifies a risk area based on the inappropriate driving information received from the plurality of in-vehicle apparatuses, wherein the travel place or an area around the travel place in which the degree of inappropriate driving is prone to reach the predetermined coping level is identified as the risk area by the area identifying device; and
a server-side transmitting device that causes the server-side communication device to transmit a level decrease command to the plurality of vehicles, the level decrease command requesting that the predetermined coping level be decreased in the risk area,
wherein
in cases where (i) the coping device receives the level decrease command via the in-vehicle-side communication device and (ii) the travel place of the own vehicle is in the risk area associated with the received level decrease command,
the coping device takes the measures against the inappropriate driving, provided that the degree of inappropriate driving reaches the predetermined coping level that is decreased in accordance with the received level decrease command.

2. The driving assist system according to claim 1, wherein:
the inappropriate driving includes at least one of drowsy driving and inattentive driving.

3. The driving assist system according to claim 1, wherein:
each of the plurality of in-vehicle apparatuses further includes
a determination device that determines a travel condition of the own vehicle when the own vehicle travels the travel place located by the travel place locating device;
when the degree of inappropriate driving reaches the predetermined coping level, the in-vehicle-side transmitting device transmits the inappropriate driving information which indicates, in addition to the travel place, the travel condition in the travel place determined by the determination device;
based on the inappropriate driving information received from the plurality of in-vehicle apparatuses, the area identifying device identifies, in addition to the risk area, a risk travel situation in the risk area, wherein the travel condition that occurs with predetermined high frequency or more in the risk area when the degree of the inappropriate driving reaches the predetermined coping level is identified as the risk travel situation;
the level decrease command transmitted from the server-side transmitting device to the plurality of in-vehicle apparatuses requests that when the travel condition of the own vehicle corresponds to the risk travel situation in the risk area, the predetermined coping level be decreased;
when receiving the level decrease command, the coping device takes the measures provided that
(i) the travel place of the own vehicle is in the risk area associated with the received level decrease command and
(ii) the travel condition determined by the determination device corresponds to the risk travel situation associated with the received level decrease command.

4. The driving assist system according to claim 3, wherein:
the travel condition includes at least one of
a time when the own vehicle travels the travel place and
a traveling direction of the own vehicle in the travel place.

5. An in-vehicle apparatus mounted to a vehicle and configured to communicate with a server located outside of the vehicle, the in-vehicle apparatus comprising:
a measurement device that measures a level of inappropriate driving done by a driver of the vehicle;
a warning device that warns the driver against the inappropriate driving when the level of inappropriate driving reaches a threshold level;
a location determining device that determines a location of the vehicle; and
an in-vehicle-side communication device that communicates with the server,
wherein,
the threshold level depends on a location of the vehicle,
the server collects inappropriate driving information from a plurality of vehicles,
the inappropriate information indicates a location where the level of inappropriate driving reaches the threshold level,
the server identifies a risk area based on the collected inappropriate driving information,
the server transmits a level decrease command to the in-vehicle apparatus,
the level decrease command requests the in-vehicle apparatus to decrease the threshold level of the risk area,
said in-vehicle-side communication device transmits the inappropriate driving information to the server, and
in cases where the in-vehicle apparatus receives the level decrease command, said warning device warns the driver based on the level of inappropriate driving and a decreased threshold level caused by the level decrease command.

6. A server communicable with a plurality of in-vehicle apparatuses, the server comprising:
a server-side communication device that communicates with the plurality of in-vehicle apparatuses, wherein the plurality of in-vehicle apparatuses is mounted to a plurality of vehicles, respectively;
an area identifying device that identifies a risk area based on inappropriate driving information received from the plurality of in-vehicle apparatuses, wherein the inappropriate driving information received from each of the plurality of in-vehicle apparatuses indicates a travel place of a corresponding one of the plurality of vehicles when the degree of inappropriate driving reaches a predetermined coping level, wherein the travel place or an area around the travel place in which the degree of inappropriate driving is prone to reach the predetermined coping level is identified as the risk area by the area identifying device; and
a server-side transmitting device that causes the server-side communication device to transmit a level decrease command, which requests that the predetermined coping level be decreased in the risk area, to the plurality of vehicles.

7. A driving assist method comprising
measuring, with use of each of in-vehicle apparatuses, a degree of inappropriate driving done by a driver of an own vehicle, which is a vehicle equipped with the each of the in-vehicle apparatuses;
taking measures, with use of each of the in-vehicle apparatuses, against the inappropriate driving when the degree of inappropriate driving reaches a predetermined coping level;
transmitting inappropriate driving information from each of the in-vehicle apparatuses to a server, wherein the inappropriate driving information indicates a travel place of the own vehicle when the degree of inappropriate driving reaches the predetermined coping level;
identifying a risk area based on the inappropriate driving information received from the in-vehicle apparatuses, wherein the travel place or an area around the travel place in which the degree of inappropriate driving is prone to reach the predetermined coping level is identified as the risk area by the server; and
transmitting a level decrease command, which requests that the predetermined coping level be decreased in the risk area, from the server to the in-vehicle apparatuses,
wherein
in cases where (i) the level decrease command is received via the in-vehicle-side communication device and (ii) the travel place of the own vehicle is in the risk area associated with the received level decrease command,
the measures against the inappropriate driving are taken in the own vehicle provided that the degree of inappropriate driving reaches the predetermined coping level that is decreased in accordance with the received level decrease command.
